(19) United States
(12) Patent Application Publication
(10) Pub. No.: US 2004/0018849 A1
(43) Pub. Date: Jan. 29, 2004

(54) Queue length-based data transmission for wireless communication

(76) Inventor: Leornard N. Schiff, San Diego, CA (US)

Correspondence Address: Qualcomm Incorporated, Patents Department, 5775 Morehouse Drive, San Diego, CA, 92121-1714, US

(21) Appl. No.: 10/397,764

(22) Filed: Mar. 25, 2003

Related U.S. Application Data
(60) Provisional application No. 60/398,159, filed on Jul. 23, 2002.

(51) Int. Cl. H04Q 7/20

(52) U.S. Cl. 455/522; 455/517; 455/427

(57) ABSTRACT

In a communication system, controlling transmission power and transmission data rate to reduce transmission power fluctuations. Data for transmission is queued in a data storage queue, and the amount of data in the queue is represented by a queue length. When the queue length is within a predetermined range, queued data is transmitted at a first power level and data rate. When a determination is made that the queue length is outside the predetermined range, a corresponding change to transmission power and data rate is made. When the queue length is exceeds a predetermined upper limit, transmission power and data rate are increased. When the queue length is less than a predetermined lower limit, transmission power and data rate are decreased. In a further aspect, the magnitude of changes to transmission power and data rate are based, at least in part, on the magnitude by which the queue length is outside the predetermined range.

### CROSS-REFERENCE TO RELATED APPLICATION

This application claims the benefit of priority of U.S. Provisional Application No. 60/398,159, filed on Jul. 23, 2002, pending, which application is incorporated herein by reference in its entirety.

### I. FIELD OF INVENTION

The present invention relates generally to the field of data communication, and more particularly to wireless data communications.

II. BACKGROUND OF THE INVENTION

Many forms of data communication systems, including both wired and wireless, have been developed over the years. Wireless communication systems have included both terrestrial-only systems with transmitters and receivers on the ground, as well as satellite communications systems that integrate a space-based component with terrestrial transmitters and receivers. Both terrestrial-only systems and satellite communications systems have facilitated providing electronic data communication service to multiple users over a majority of the globe.

In order to facilitate multiple users in using a wireless communication system, multiple access schemes may be utilized. Examples of multiple access schemes are frequency division multiple access (FDMA), time division multiple access (TDMA), code division multiple access (CDMA), and various hybrids thereof.

In order to effectively transmit data to multiple users in various areas, data rates and/or transmission power for the data transmission are often controlled. Examples of methods for controlling data rates and/or transmission power include a method where data rates and transmission power may both be fixed at a predetermined level; a method where data rates may vary while transmission power may be fixed, and vice versa; and a method where both data rates and transmission power may be varied.

Transmitting at an “average” power level has the advantage of being steady and potentially lower in interference, but may not be the most efficient in terms of the volume of data transmitted. Lower power transmission is especially useful in reducing interference in multi-cell or multi-beam communication systems where the same frequencies are reused in other nearby cells or beams. In addition, providing “steady” power output prevents or reduces the occurrence of interference levels that fluctuate to high levels or levels that are considered significantly higher than average, which has the impact of reducing system capacity.

Transmitting at a higher power level has the advantage of allowing an increase in the transmission data rate, but can result in an increased occurrence of a data queue becoming empty. At such time, with no data to be transferred, the transmission power is zero. Accordingly, the transmission power becomes bursty in nature, and in turn, causes interference.

What is needed are methods and apparatus for balancing the requirements of high data rate transmission and reduced occurrence of bursty transmission characteristics.

### SUMMARY OF THE INVENTION

Briefly, embodiments of the present invention facilitate controlling transmission power, and transmission data rate, in wireless communication systems. In a wireless communication system, data for transmission is queued in a data storage queue, and the amount of data in the queue is represented by a value referred to as a queue length. When the queue length is within a predetermined range, the queued data is transmitted at a first power level and data rate. When a determination is made that the queue length is outside the predetermined range, a corresponding change to transmission power and transmission data rate is made. In those circumstances wherein the queue length is greater than the predetermined range, transmission power and data rate are increased. In those circumstances wherein the queue length is less than the predetermined range, transmission power and data rate are decreased.

In a further aspect of the present invention the changes to transmission power and transmission data rate are based, at least in part, on the magnitude by which the queue length is outside the predetermined range.

### BRIEF DESCRIPTION OF DRAWINGS

The present invention will be described by way of exemplary embodiments, but not limitations, illustrated in the accompanying drawings in which like references denote similar elements, and in which:

FIG. 1 illustrates an exemplary operating environment for one embodiment of the present invention;

FIG. 2 illustrates an overview of the present invention, in the context of a wireless communication device;

FIG. 3 illustrates the data queue 204 of FIG. 2;

FIG. 4 illustrates the operational flow of an exemplary method of power control in accordance with the present invention; and

FIG. 5 illustrates an example gateway, within which an embodiment of the present invention may be practiced.

### DETAILED DESCRIPTION

In the following description, various aspects will be described. However, it will apparent to those skilled in the art that various embodiments may be practiced with only some or all aspects. For purposes of explanation, specific numbers, materials and configurations are set forth in order to provide a thorough understanding. However, it will be also apparent to one skilled in the art that various embodiments may be practiced without the specific details. In other instances, well-known features are omitted or simplified in order not to obscure the present invention.

Parts of the description will be presented using terminology commonly employed by those skilled in the art to convey the substance of their work to others skilled in the art. Also, parts of the description will be presented in terms of operations performed through the execution of programming instructions. As well understood by those skilled in the art, these operations often take the form of electrical, magnetic, or optical signals capable of being stored, transferred, combined, and otherwise manipulated through, for instance, electrical components.

References herein to “one embodiment”, “an embodiment”, or similar formulations, means that a particular feature, structure, or characteristic described in connection with the embodiment, is included in at least one embodiment. Thus, the appearances of such phrases or formulations herein are not necessarily all referring to the same embodiment. Furthermore, various particular features, structures, or characteristics may be combined in any suitable manner in one or more embodiments.

For purposes of providing an illustrative description, reference is made herein to queue length. The queue length may be measured in terms of data packets, bytes, or bits, or the time to transmit (i.e., empty) the queued data. It is noted that the metrics used in connection with the queue length do not limit the invention in any way.

Various embodiments of the present invention provide advantageous methods and apparatus for controlling transmission power and transmission data rate in wireless communication systems.

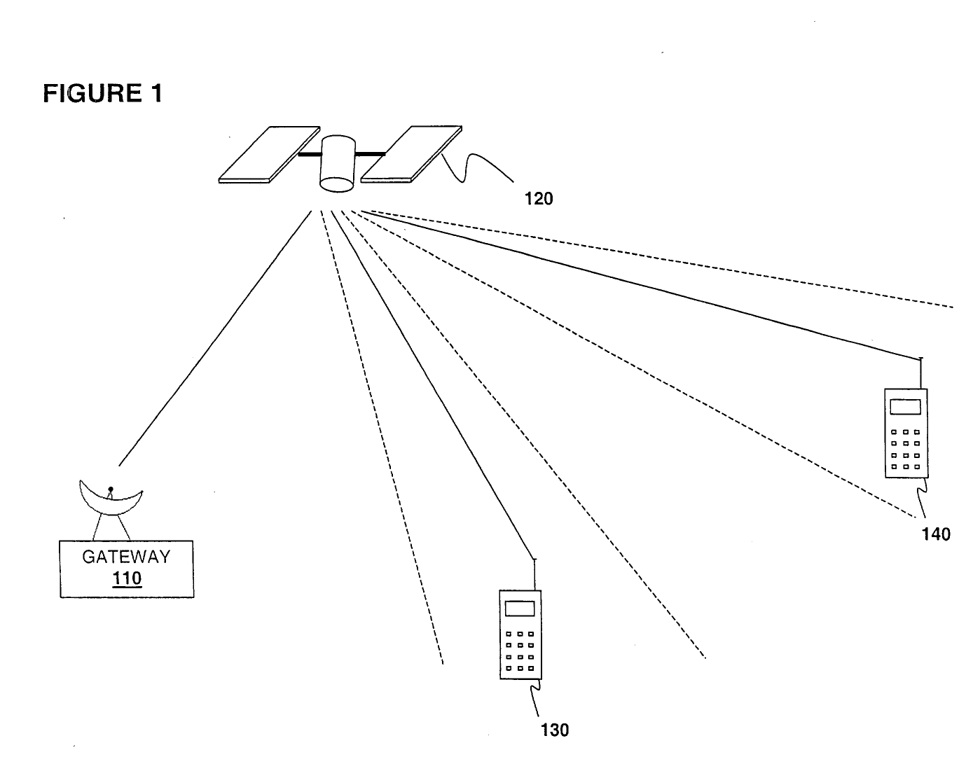

FIG. 1 illustrates an exemplary operating environment for one embodiment of the present invention. Shown in FIG. 1 is a gateway 110 transmitting forward channel data to user devices 130, 140 through communications satellite 120. The terms base station and gateway are sometimes used interchangeably in this field, with gateways being perceived as specialized base stations that direct communications through satellites, while base stations use terrestrial antennas to direct communications within a surrounding geographical region. User devices are also sometimes referred to as subscriber units, user terminals, access terminals, mobile units, mobile stations, or simply “users”, “mobiles”, “subscribers”, or the like. User devices 130, 140 transmit reverse channel data to gateway 110 through satellite 120 as indicated in FIG. 1.

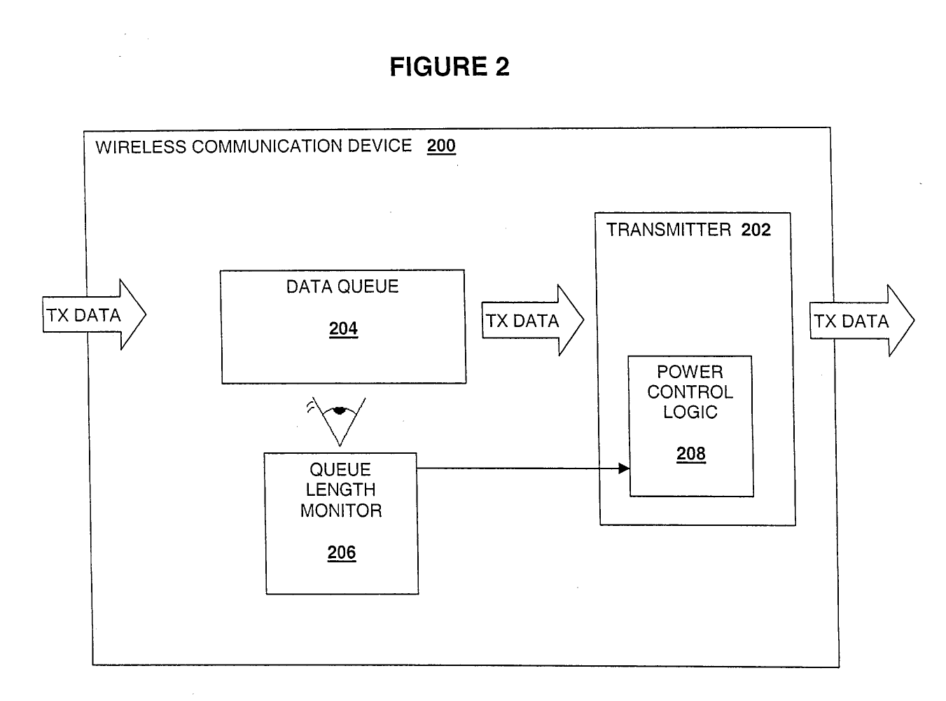

FIG. 2 illustrates an overview of the present invention, in the context of a wireless communication device. Wireless communication device 200 may be a component of a wireless communication environment, such as, but not limited to, the environment illustrated in FIG. 1. For example, wireless communication device 200 may be a component of the gateway 110 transmitting forward channel data to user devices 130, 140 through communications satellite 120 (shown in FIG. 1), and also providing user devices 130, 140 with access to fixed networks, such as public switched telephone networks, public land mobile networks, etc., within the users' coverage area. It is noted that the transmission of data may be in the form of various multiple access schemes, such as, but not limited to, an orthogonal code division multiple access scheme.

As illustrated in FIG. 2, the wireless communication device 200 includes a data queue 204 for queuing, i.e., temporary storage, of transmit (TX) data, before that data is provided to a transmitter 202 for transmission.

In accordance with one embodiment, wireless communication device 200 is advantageously provided with a queue length monitor 206 to monitor the queue length of data in the data queue 204. Further, transmitter 202 is advantageously provided with power control logic, or power controller, 208 to issue power control commands to a power provider, based on the states of data queue 204 as reported by queue length monitor 206. The power provider may be, for example, a variable output high power amplifier. As a result, data is transmitted with variable transmission power, based in part on the queue length of the data in the data queue 204. Similarly, the data rate may be adjusted responsive to the queue length.

For ease of understanding, it is assumed that a transmission power is related to a transmission data rate. Accordingly, for the purposes of this description, an increase in transmission power corresponds with an increase in transmission data rate. Similarly, a decrease in transmission power corresponds with a decrease in transmission data rate.

As will be described in more detail below, power control logic 208 facilitates transmitting data at a first power level, which may be a predetermined power level. The predetermined power level may be a power level that effectively transmits data at a nominal rate. Accordingly, for the purposes of the description, the first power level will be referred to as nominal power level. Adjusting the nominal power level to compensate for changes in the queue length advantageously reduces power level fluctuations, in accordance with the present invention.

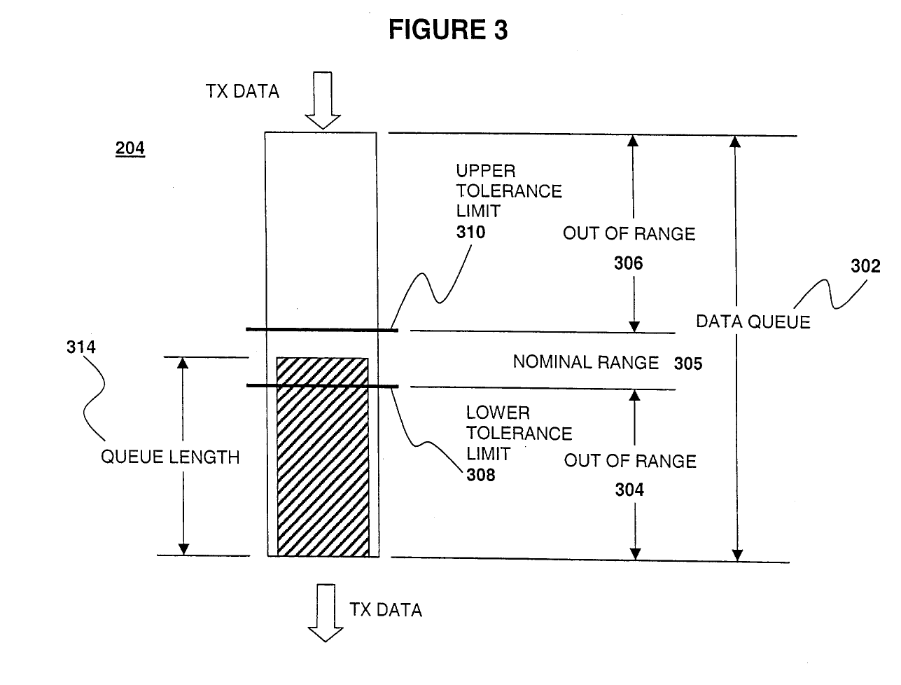

FIG. 3 illustrates the data queue 204 of FIG. 2 in further detail. Data queue 204 facilitates queuing of data, and may be a type of storage medium, such as, but not limited to, a First-In First-Out (FIFO) storage medium. Such storage media includes, but is not limited to, serial memory, such as shift registers, and random access memory (RAM), such as static RAM or dynamic RAM. Accordingly, data queue 204 includes data buffers (not explicitly shown) for storing the data, and associated control circuitry (not shown) for controlling the writing of the data into the data buffers. The control circuitry includes in particular, queue length monitor 206 (shown in FIG. 2), which provides the ability to report the queue length in the data queue 204. In alternative embodiments, a queue length monitor may simply report a “speed-up” or “slowdown” message, or signal, rather than the queue length itself.

It is noted that any suitable method for determining queue length may be used to implement the various embodiments of the present invention. By way of illustration, and not limitation, a counter may be incremented as data items are added to the queue, and decremented as data items are provided from the queue to the transmitter. In another example, the queue has associated head and tail pointers which contain the addresses of the beginning and end of the currently queued data. A difference between the head and tail addresses is determined by any suitable means, including but not limited to, digital subtraction. The difference between the head and tail addresses is representative of the amount of data that is currently queued in data queue 204.

As described earlier, power control logic 208 (shown in FIG. 2) facilitates transmitting data at a nominal power level, and adjusting the power level to compensate for changes in the queue length in the data queue 204.

As illustrated in the embodiment of FIG. 3, data queue 204 has a physically limited data storage capacity 302. The data storage capacity 302 is shown being characterized by first, second, and third portions, or ranges, 304, 305, 306. In one embodiment, first portion 304 (out of range low) occupies approximately one third of the capacity 302, and extends up to a low tolerance limit 308. The second portion 305 (nominal range) occupies approximately one third of the data storage capacity 302, and ranges from the lower limit 308 to an upper limit 310. The third portion 306 (out of range high) occupies approximately the remaining one third of the data storage capacity 302, and ranges from the upper limit 310 to the extent of the data storage capacity 302. The lower and upper limits 308 and 310 denote levels of queue lengths, below and above which the power control logic 208 is actively employed to adjust the transmission power, and transmission data rate, to maintain a queue length between the low tolerance limit 308 and the high tolerance limit 310. Accordingly, in the illustrative embodiment of FIG. 3, the second portion 305 may be a nominal power level range, within which, data is transmitted at the nominal power and data rate.

In the illustrative embodiment of FIG. 3, queue length 314 is in the nominal range 305, that is, the queue length 314 is greater than the low tolerance limit 308 and less than the high tolerance limit 310. Queue length monitor 206 reports the queue length 314 to the power control logic 208 (both shown in FIG. 2). Based at least in part on the reported queue length 314, which is within the nominal range 305, power control logic 208 facilitates transmitting data at the nominal power level and data rate. The nominal power level may be established based at least in part on the requirements of a particular wireless communication system, within which, the transmission is to occur. When transmitting data at the nominal power level, the rate at which the data is transmitted may be at a maximum rate allowed by the nominal power level (i.e., a nominal data rate for transmission). Further, in the illustrative embodiment, the data transmitted at the nominal power level may be spread across two or more time slots to prevent having a time slot that may become empty of data transmission.

As will be further described, in accordance with the embodiment, the power level may be adjusted from the nominal power level to different power levels to facilitate compensation for changes in the queue length 314 in the data queue 204.

In an alternative embodiment, the power level may be adjusted from the nominal power level to different power levels to facilitate compensation for the amount of time required to process data in the data queue 204. For example, in FIG. 3, even though the queue length 314 is shown being within the nominal range 305, an amount of time for data transmitted at the nominal power level may be longer than desired by a recipient (not shown) because the particular recipient may be able to receive data at a faster rate than the nominal transmission power allows. That is, the total time required for the data transfer through the queue may be beyond desired limits of the recipient. Accordingly, the control circuitry may also include facilities to calculate time required for data transfer through the data queue 204, and this information may be reported to the power control logic 208. If the reported time for data transfer is below or above desired levels, the power control logic 208 may adjust the transmit power and/or data rate based, at least in part, on the deviation below or above desired levels to increase or decrease the data rate for transmission. For the purposes of describing the invention, the term recipient includes users, terminals, and the like, for receiving transmissions within a wireless communication system.

In typical embodiments, the nominal range 305 is configurable, and accordingly, both tolerance limits 308 and 310 are also configurable. Such configuration may be facilitated via any one of a number of configuration techniques known in the art.

With respect to the configurability of the lower and upper limits 308, 310, in one illustrative embodiment, lower limit 308 and upper limit 310 may be stored as digital values in registers. It is noted that values for the lower and/or upper limits 308, 310 may be programmed once, or may be reprogrammed many times depending on the goals established by various designers for specific implementations of embodiments. In the illustrative embodiment, a determination as to whether the queue length is within the nominal range 305 can be made by comparing the queue length to lower limit 308 and upper limit 310. In one embodiment, if the queue length is less than the upper limit and greater than the lower limit, then the queue length is determined to be within the nominal range, and changes to transmission power and data rate are not deemed needed. If the queue length is greater than the upper limit or less than the lower limit, then, in accordance with the present invention adjustments are made to transmit power and data rate. Those skilled in the art will recognize that there are a number of similar variations to the above described architecture and method.

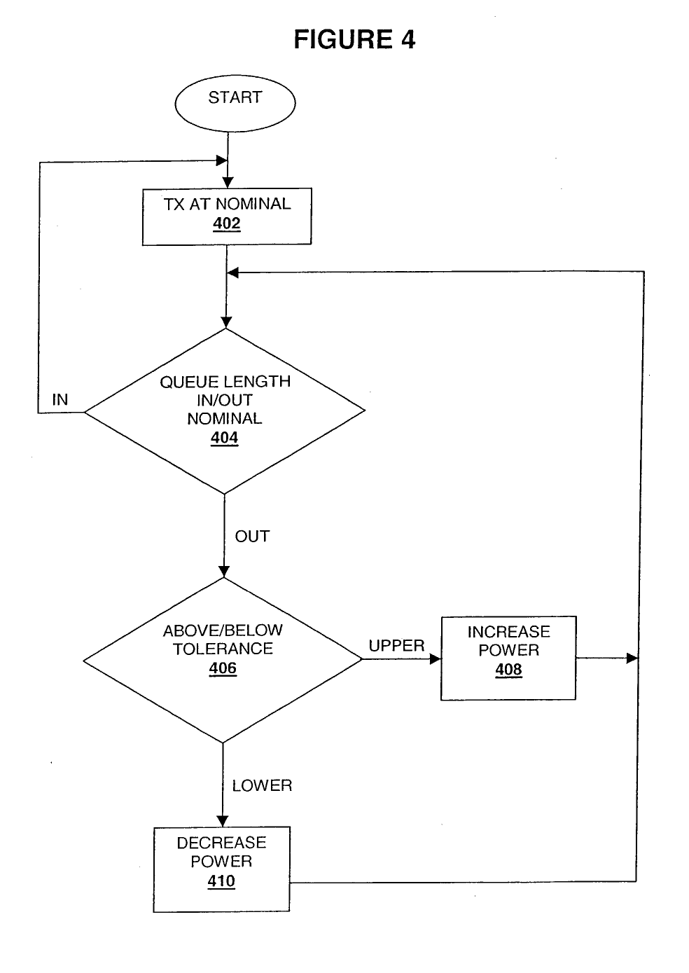

FIG. 4 illustrates the operational flow of the relevant methods of power control logic 208 (shown in FIG. 2) in further detail, in accordance with one embodiment. At block 402, power control logic 208 facilitates transmission of data at a first power level based, at least in part, on a queue length at a first point in time. As previously described, the queue length 314 at the first point in time, is preferably within the nominal range 305 (shown in FIG. 3) resulting in the first power level being at a nominal power level.

The power control logic 208 determines, at a second point in time, whether the queue length is within or outside the nominal range 305, at block 404. If it is determined that the queue length is outside the nominal range 305, power control logic 208 continues on to determine if the queue length is below the lower tolerance limit 308 or above the high tolerance limit 310, at block 406. However, if it is determined that the queue length is within the nominal range 305, the power control logic 208 continues transmission of data at the nominal power level.

If the queue length, at the second point in time, is above the upper tolerance limit 310, power control logic 208 initiates adjustment of the transmit power so as to transmit data at an increased data rate, at block 408. That is, the nominal transmission power may be adjusted to an increased power level that is consistent with an increased rate of data transmission, The increased transmission data rate, in turn, acts to reduce the queue length in the data queue 204. The increased power level may be proportional to the increase in rate of data transmission that is useful to bring the queue length in the data queue 204 back into the nominal range 305 (i.e., below the high tolerance limit 310 and above the low tolerance limit 308). The proportionality may be based at least in part on an amount that the queue length is above the high tolerance limit 310.

On the other hand, if the queue length, at the second point in time, is below the lower tolerance limit 308, power control logic 208 initiates transmission of data at decreased transmission power that is lower than the first power level, at block 410. The decreased power level and associated reduction in data rate allows the queue length in the data queue 204 to grow back into the nominal range 305, thereby avoiding the undesirable situation of having an empty queue which results in transmit power going to zero. The decreased power level may be proportional to the decrease in rate of data transmission that is appropriate to bring the queue length in the data queue 204 back into the nominal range 305 (i.e., above the lower limit 308 and below the upper limit 310). The proportionality may be based at least in part on an amount that the queue length is below the lower limit 308.

Additionally, the change in power level described above may be linear or non-linear, configurable, etc., relative to the queue lengths required to bring the queue length back into the nominal range. Accordingly, in the illustrated embodiment of FIG. 4, once the power level has been either increased or decreased, it is again determined if the queue length is within or outside the nominal range, at block 404.

As a result, power levels utilized to transmit data are advantageously controlled, and transmit power fluctuations are reduced.

The embodiments illustrated in FIGS. 1 through 3 include a number of implementation specific details. Other embodiments may include additional elements, may not include all the illustrated elements, may combine or separate one or more elements, arrange elements in different configurations or orders, etc. Additionally, various embodiments of the present invention make use of computational resources to carry out the above-described functionality.

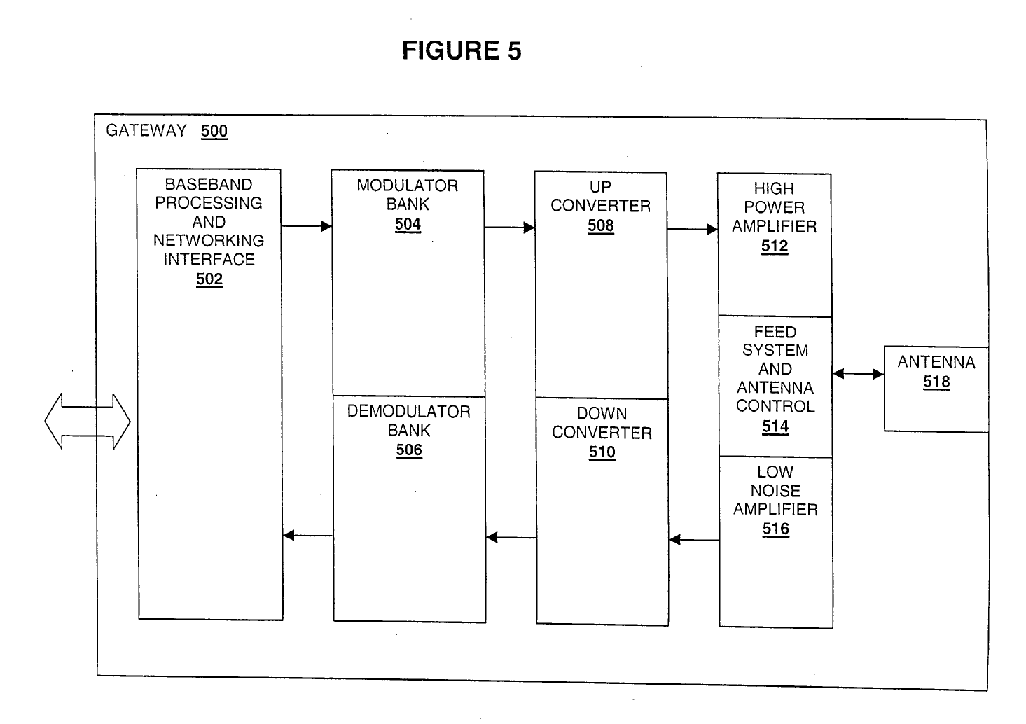

FIG. 5 illustrates an example gateway, within which an embodiment of the present invention may be practiced. Example gateway 500 includes antenna 518, amplifiers 512 and 516, feed system and antenna control 514, up/down converters 508 and 510, modulator/demodulator banks 504 and 506, and baseband processing and network interface 502. In particular, baseband processing and network interface 502 includes the queue length based data transmission control of the present invention.

Transmit data are received, processed and encoded by the baseband processor and network interface 502, and then modulated onto a signal by modulator 506. The modulated signal is up converted by up converter 508 and amplified through high power amplifier 512. The amplified signal is then fed to antenna 518 through feed system and antenna control 514, for transmission.

Received signals are amplified by the low noise amplifier 516. The amplified signals are then down converted by down converter 510 and demodulated by demodulator 506. Data recovered from the demodulated signals are processed by baseband processor and network interface 502, and provided to other elements of the communication system of which gateway 500 is a part.

Except for baseband processor and network interface 502 being incorporated with the teachings of the present invention, other enumerated elements represent a broad range of such elements known in the art. Moreover, other gateway or gateway-like apparatus, such as a base station, may have more or less of these elements, or have some of these elements substituted with other equivalent elements.

In alternative embodiments, the present invention may be implemented in discrete hardware or firmware. For example, one or more application specific integrated circuits (ASICs) could be programmed with one or more of the above described functions of the present invention. In another example, one or more functions of the present invention could be implemented in one or more ASICs on additional circuit boards and the circuit boards could be inserted into the computer(s) described above. In another example, field programmable gate arrays (FPGAs), or similar devices, could be used to implement one or more functions of the present invention. In yet another example, a combination of hardware and software could be used to implement one or more functions of the present invention.

In another alternative embodiment, prior to transmitting at least a portion of the stored data, information is transmitted to at least one terminal indicating to the at least one terminal which demodulation scheme to be used by the at least one terminal. In this way, a variety of modulation schemes can be used consistent with changing the transmit data rate in accordance with the queue length management of the present invention

Thus, advantageous methods and apparatus for controlling transmission power and/or data rates in wireless communication systems are described. Whereas many alterations and modifications of the present invention will be comprehended by a person skilled in the art after having read the foregoing description, it is to be understood that the particular embodiments shown and described by way of illustration are in no way intended to be considered limiting. Therefore, references to details of particular embodiments are not intended to limit the scope of the claims.

It is to be understood that the present invention is not limited to the embodiments described above, but encompasses any and all embodiments within the scope of the subjoined claims and their equivalents.

What is claimed is:

1. A method of varying transmission data rate, comprising:
at a first time, transmitting data queued in a queue at a first power level and a first data rate;
determining, at a second time, whether the queue length of the queue is outside of a predetermined range; and
transmitting, if the determination is affirmative, data queued in the queue at a second data rate, the second data rate being selected based at least in part on an amount by which the queue length is outside the predetermined range.

2. The method of claim 1, further comprising transmitting at a second power level wherein the second power level is consistent with achieving the second data rate.

3. The method of claim 1, wherein determining comprises determining whether the queue length is below a lower limit.

4. The method of claim 3, wherein if, at the second time, the queue length is below the lower limit, then the data is transmitted at a second power level that is less than the first power level, wherein the second power level based, at least in part, on an amount by which the queue length is below the lower limit.

5. The method of claim 1, wherein determining comprises determining whether the queue length is above an upper limit.

6. The method of claim 5, wherein if, at the second time, the queue length is above the upper limit, the second power level is more than the first power level, the second power level based at least in part on an amount by which the queue length is above the upper limit.

7. A method of transmitting data, comprising:
establishing a nominal transmit power and nominal data rate;
storing an amount of data for transmission in a queue, the amount of data in the queue at any time represented a queue length;
monitoring the queue length;
increasing the data rate if the queue length is greater than a first predetermined amount; and
decreasing the data rate if the queue length is less than a second predetermined amount.

8. The method of claim 7, further comprising increasing the transmit power if the queue length is greater than a first predetermined amount.

9. The method of claim 8, further comprising decreasing the transmit power if the queue length is less than a second predetermined amount.

10. The method of claim 9, further comprising storing the first predetermined amount in an upper limit register, and storing the second predetermined amount in a lower limit register.

11. A method of controlling a communication process, comprising:
determining an amount of stored data to be transmitted to a recipient;
modifying a transmission data rate from a nominal value based, at least in part, on a first amount of time, the first amount of time being the time required to transmit the stored data; and
transmitting at least a portion of the stored data at the modified transmission data rate.

12. The method of claim 11, wherein modifying the transmission data rate comprises increasing the transmission data rate if the first amount of time is greater than a first predetermined amount of time.

13. The method of claim 11, wherein modifying the transmission data rate comprises decreasing the transmission data rate if the first amount of time is less than a second predetermined amount of time.

14. The method of claim 11, wherein modifying the transmission data rate comprises increasing the transmission data rate if the first amount of time is greater than a first predetermined amount of time, and decreasing the transmission data rate if the first amount of time is less than a second predetermined amount of time.

15. The method of claim 14, wherein the first and second predetermined amounts of time are the same.

16. The method of claim 13 wherein the second predetermined amount of time is selected such that an empty que is avoided.

17. The method of claim 14, wherein the second predetermined amount of time is selected such that an empty time slot is avoided.

18. The method of claim 11, further comprising receiving an indication of the data rate at which at least one wireless communication device can receive data.

19. The method of claim 14, further comprising receiving, from each of a plurality of terminals, an indication of a data rate at which data is to be transmitted to each of the plurality of terminals.

20. The method of claim 14, further comprising, prior to transmitting at least a portion of the stored data, transmitting information to at least one terminal, the information indicating to the at least one terminal a demodulation scheme to be used by the at least one terminal.

21. A gateway of a wireless communication system, comprising:
an amplifier coupled to the antenna and adapted to provide a controllable transmission power level;
a converter coupled to the amplifier;
a modulator bank coupled to the converter;
a baseband processing and network interface coupled to the modulator bank; and
a power controller, coupled to the baseband processing and network interface, the power controller adapted to change the transmission power level and transmission data rate based, at least in part, on a queue length;
a queue length monitor coupled to the power controller; and
a transmit data queue coupled to the queue length monitor.

22. The gateway of claim 21, further comprising an upper limit register and a lower limit register, each coupled to the power controller.

23. The gateway of claim 21, wherein the upper and lower limit registers are programmable.
